(19) United States
(12) Patent Application Publication
(10) Pub. No.: US 2004/0093976 A1
(43) Pub. Date: May 20, 2004

(54) Collapsible steering column

(76) Inventors: Gerald F. Burke, Livonia, MI (US); Satish Venkatachalapathy, Auburn Hills, MI (US)

Correspondence Address: Donald J. Wallace, DaimlerChrysler Intellectual Capital Corporation, CIMS 483-02-19, 800 Chrysler Drive, Auburn Hills, MI, 48326-2757, US

(21) Appl. No.: 10/294,841

(22) Filed: Nov. 14, 2002

(51) Int. Cl. B62D 1/19

(52) U.S. Cl. 74/492; 280/777

(57) ABSTRACT

A steering column for a motor vehicle comprises a main body having upper and lower attachment points. The lower attachment point includes at least one closed-end slot having a ramped surface. A washer having a ramped surface is engaged with the ramped surface of the slot, and a fastener extends through the slot and through the washer.

### FIELD OF THE INVENTION

This invention relates generally to steering columns for motor vehicles, and relates more particularly to a collapsible steering column.

### BACKGROUND OF THE INVENTION

Steering columns for motor vehicles need to be relatively stable in order to support the load of an attached steering wheel during regular driving conditions. Steering columns thus may be attached to an instrument panel support structure by means of an upper and a lower support. Steering columns may also be required under certain circumstances to collapse quickly. In these circumstances, it may be desirable for fasteners connecting the steering column to the upper and lower supports to allow such collapse without impediment.

### SUMMARY OF THE INVENTION

The present invention is a steering column for a motor vehicle. The steering column comprises a main body having an upper attachment and a lower bracket. The lower bracket includes at least one slot having at least one ramped surface. A washer having a ramped surface is engaged with the surface of the slot, and at least one fastener extends through the slot and through the washer.

Accordingly, it is an object of the present invention to provide a steering column of the type described above that is collapsible.

Another object of the present invention is to provide a steering column of the type described above that is collapsible in a relatively controlled manner.

Still another object of the present invention is to provide a steering column of the type described above having a lower bracket with at least one ramped surface.

These and other features and advantages of the invention will become further apparent from the following detailed description of the presently preferred embodiments when read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a side view of a steering column assembly according to the present invention for a motor vehicle.

FIG. 2 is a perspective view of a main body of the steering column assembly.

FIG. 3 is a perspective view of a portion of the underside of the main body.

FIG. 4 is a cross-sectional view taken along line 4-4 in FIG. 2 and showing the main body mounted on the steering column assembly.

### DETAILED DESCRIPTION OF THE PREFERRED EMBODIMENTS

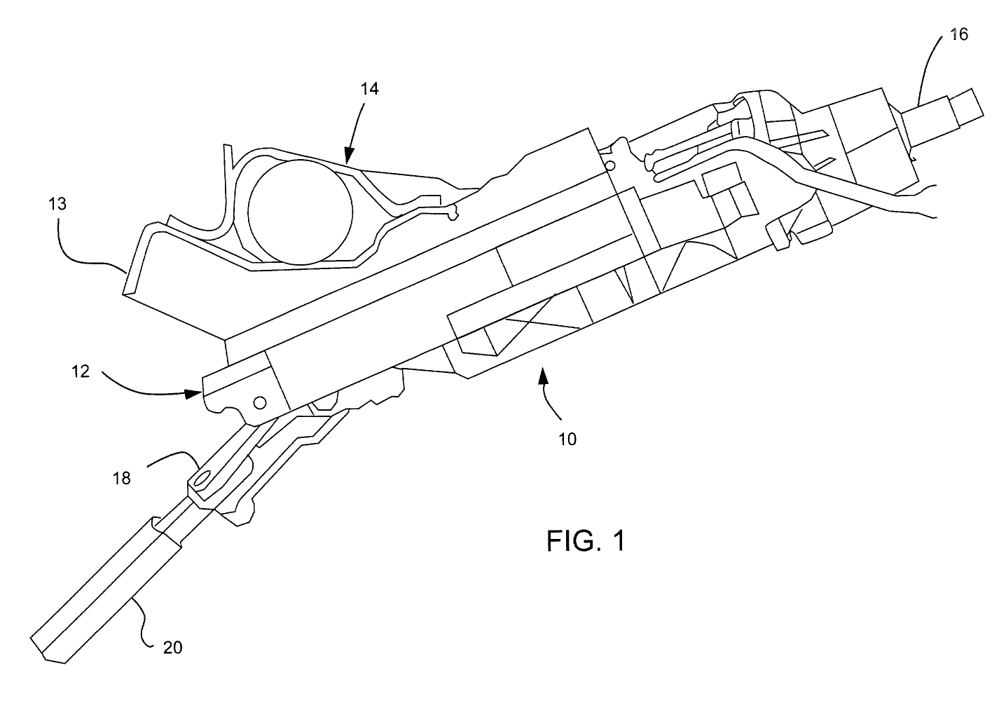

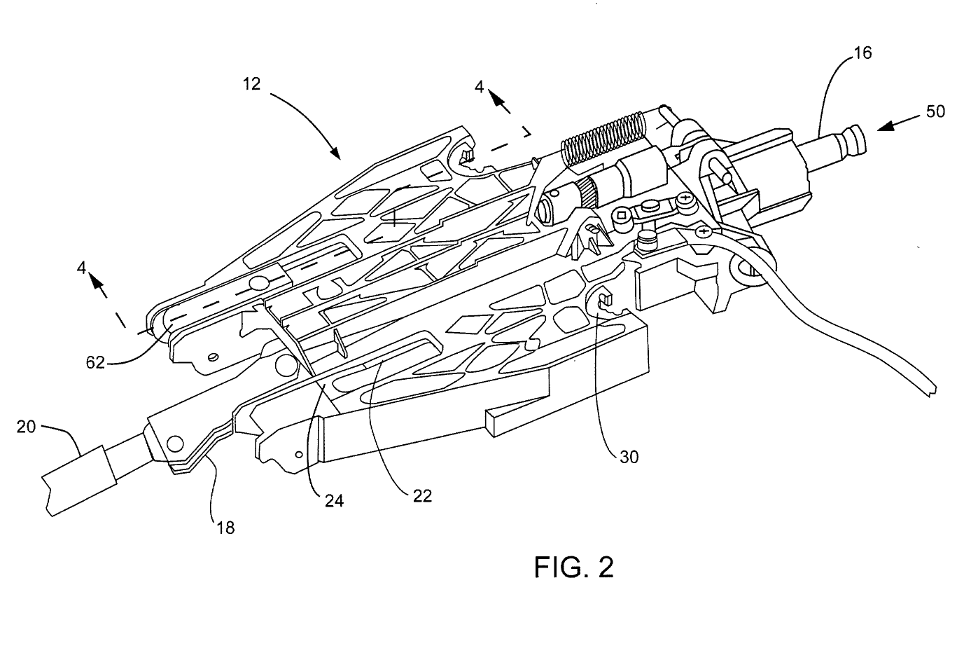

FIGS. 1 and 2 show one embodiment 10 of a steering column assembly according to the present invention for a motor vehicle. The steering column assembly 10 includes a main body 12 that is preferably a casting attached by a mounting bracket 13 to a stationary wall 14, which may be part of an instrument panel mounting structure. The main body 12 includes a steering column shaft 16, a yoke 18 and an intermediate shaft attachment 20. The steering column shaft 16 is adapted to accept a steering wheel (not shown) on its distal end in conventional fashion, and may be tiltable as is well known. The yoke 18 connects the steering column shaft 16 to the intermediate shaft attachment 20, which in turn is connected to a steering gear (not shown).

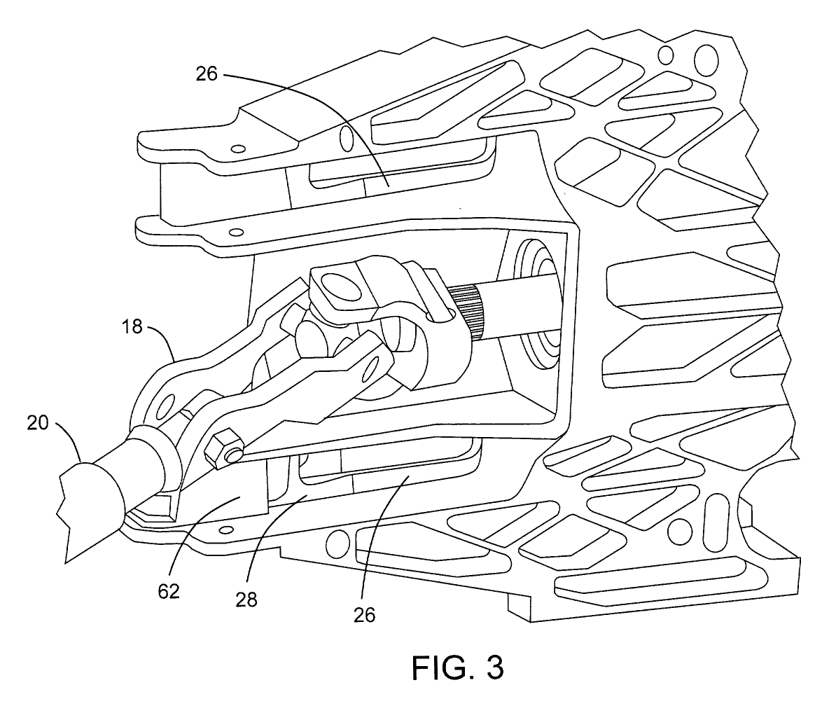

The main body 12 also includes a pair of forwardly disposed, longitudinally extending attachment walls 22 on either side of the steering column shaft 16. Each of the attachment walls 22 has a forward surface 24 that slopes upwardly. Together, the attachment walls 22 and the angled upper surfaces 24 form ramped slots with opposing upper wedged surfaces. As shown in FIG. 3, opposing surfaces 26 with wedged portions 28 are similarly formed on the lower side of the main body 12. A pair of generally semi-circular upper attachments 30 are also formed in the main body 12.

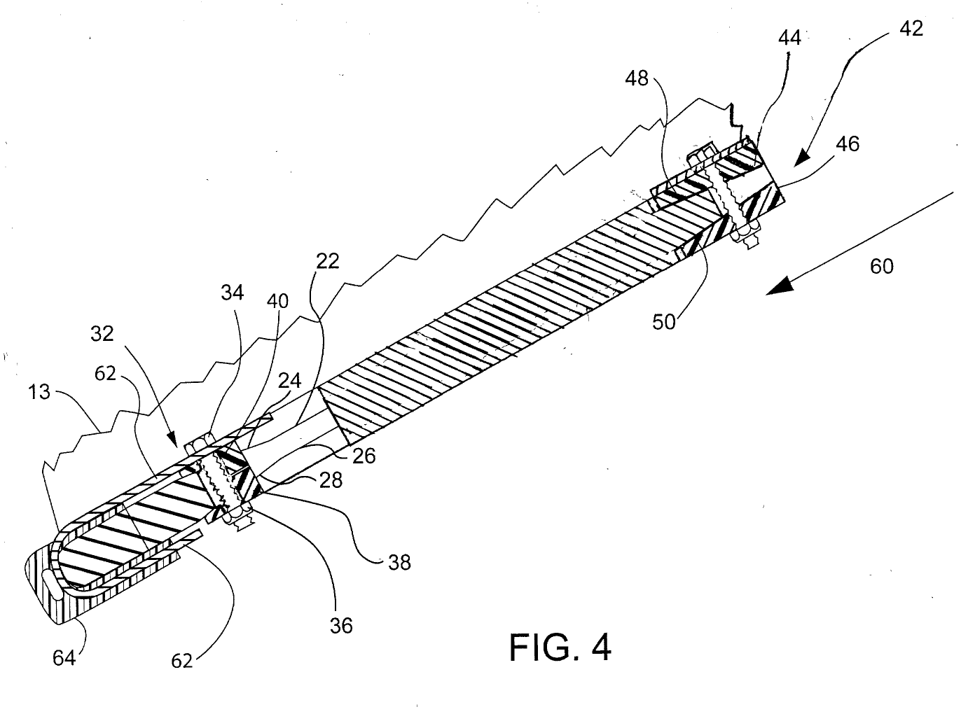

FIG. 4 shows one of a pair of lower capsule brackets 32 that connect the main body 12 to the mounting bracket 13. Each lower capsule bracket 32 includes a fastener such as a stud 34 and a nut 36 that are tightened to hold a washer 38 at a certain preload against the wedged surface 28 of the lower attachment wall 26 of the main body 12. The washer 38 is acutely angled so as to match the angle of the wedged surface 28 of the main body 12. The angle of the wedged surface 28, as well as the angle of the washer 38, affect the release load needed for the steering column 12 to overcome the preload of the studs 34. An optional upper angled washer 40 similar to the angled washer 38 may be retained by the stud 34 against the upper wedged surface 24.

The attachment walls 22 and 26, and more particularly the wedged surfaces 24 and 28, extend into the space circumscribed by the lower capsule brackets 32 such that the lower capsule brackets transmit a major portion of the weight of the steering column onto the mounting bracket 13 and the stationary wall 14. Similarly, a rearward portion of the steering column assembly 10 is attached to the mounting bracket 13 by an upper capsule bracket 42. Each upper capsule bracket 42 preferably includes two separate components 44 and 46 that are preferably formed of the same material as the washers 38 and 40. By way of example, components 44, 46 and washers 38, 40 can be formed of a plastic material having fiberglass reinforcement fibers incorporated therein and coated with nylon. The components 44 and 46 respectively include acutely angled support walls 48 and 50 engaging opposite surfaces of the main body 12. Further details of a preferred embodiment of the upper capsule bracket 42 are disclosed in U.S. Pat. No. 5,390,955 and U.S. Pat. No. 5,979,860, the disclosures of which are hereby incorporated by reference. It should be appreciated, however, that any acceptable upper bracket arrangement may be used in the present invention.

Upon an impact force in the direction of the arrow 60, the upper capsule brackets 42 release as described in the '955 and '860 patents. The preload on the studs 34 of the lower capsule brackets 32 is preferably quickly overcome such that the angled surfaces 24 and 28 of the main body 12 separate from the washers 38 and 40. The load at which the main body 12 releases can be altered by changing the angle of the mating surfaces, and also by changing the cross-sectional area of the studs, washers, and nuts of the respective brackets. Regardless of the preload, further resistance is negligible as the main body 12 translates to the left as shown in the drawings. Some or all of the energy of this translation is absorbed by bend straps 62 (only one of which is shown in the drawings) disposed around each of the lower capsule brackets 32. In a preferred embodiment, each bend strap 62 is a curved piece of metal having a varying thickness, with one end secured by the stud and slidably disposed around the steering column body. A plastic guide 64 may also be provided to hold each bend strap 62 against the steering column body.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A steering column for a motor vehicle, the assembly comprising;
a main body having an upper attachment and a lower bracket, the lower bracket including at least one slot having at least one ramped surface;
a washer having a ramped surface engaged with the surface of the slot; and
at least one fastener extending through the slot and through the washer.

2. The steering column of claim 1 wherein the slot has two ramped surfaces.

3. The steering column of claim 1 wherein the main body has two slots.

4. The steering column of claim 3 wherein each slot has two ramped surfaces.

5. The steering column of claim 1 wherein the washer is constructed of a plastic material.

6. The steering column of claim 1 wherein the washer is coated with a nylon material.

7. The steering column of claim 1 wherein the at least one fastener comprises a bolt.

8. The steering column of claim 1 further comprising at least one energy absorbing strap connected to the fastener.

9. A steering column assembly for a motor vehicle, the assembly comprising;
an upper bracket;
a lower bracket having at least one slot, the slot having at least one ramped surface;
a washer having a ramped surface engaged with the surface of the slot; and
at least one fastener extending through the slot and through the washer to secure the lower bracket at an initial position.

10. The steering column assembly of claim 9 wherein the slot has two ramped surfaces.

11. The steering column assembly of claim 9 wherein the lower bracket includes two slots.

12. The steering column assembly of claim 11 wherein each slot has two ramped surfaces.

13. The steering column assembly of claim 9 wherein the washer is constructed of a plastic material.

14. The steering column assembly of claim 9 wherein the washer is coated with a nylon material.

15. The steering column assembly of claim 9 wherein the at least one fastener comprises a bolt.

16. The steering column assembly of claim 9 further comprising at least one energy-absorbing strap connected to the fastener.

17. A steering column for a motor vehicle, the steering column comprising;
an upper bracket;
a lower bracket having two slots, each slot having at least one ramped surface;
a washer having a ramped surface engaged with the surface of each slot; and
at least one fastener extending through each slot and through each washer to secure the lower bracket at an initial position.

18. The steering column of claim 17 wherein each slot has two ramped surfaces.

19. The steering column of claim 17 wherein the washer is constructed of a plastic material and coated with a nylon material.

20. The steering column of claim 17 further comprising at least one energy-absorbing strap connected to the fastener.
